(19) United States
(12) Patent Application Publication
(10) Pub. No.: US 2023/0234166 A1
(43) Pub. Date: Jul. 27, 2023

(54) JOINED MEMBER AND METHOD OF MANUFACTURING JOINED MEMBER

(71) Applicant: HONDA MOTOR CO., LTD., Tokyo (JP)

(72) Inventors: Masaaki FUJIMOTO, Saitama (JP); Seiya OKAMURA, Saitama (JP); Kenichi FUKAMI, Saitama (JP)

(21) Appl. No.: 18/059,986

(22) Filed: Nov. 30, 2022

(30) Foreign Application Priority Data
Jan. 27, 2022 (CN) 202210100711.0

(51) Int. Cl. B23K 26/211; B23K 26/323

(52) U.S. Cl. CPC B23K 26/211; B23K 26/323; B23K 2103/18

(57) ABSTRACT

A joined member is provided which includes: a first metal member, a second metal member opposed to the first metal member, and a joining portion through which the first metal member and the second metal member are joined together, in which an end face in a width direction of the first metal member is in contact with the joining portion, a portion of a surface of the second metal member on a side opposed to the first metal member is in contact with the joining portion, and a region of the surface of the second metal member on a side opposed to the first metal member which is not in contact with the joining portion is covered with zinc, and in the joining portion, zinc concentration in at least one end portion in the width direction is higher than zinc concentration in the center portion in the width direction.

This application is based on and claims the benefit of priority from Chinese Patent Application CN202210100711.0, filed on 27 Jan. 2022, the content of which is incorporated herein by reference.

### BACKGROUND OF THE INVENTION

### Field of the Invention

The present disclosure relates to a joined member and a method of manufacturing the joined member.

### Related Art

Conventionally, a reduction in the weight of a vehicle body has been desired because it contributes to an improvement in the fuel economy of the vehicle. On the other hand, a joined member obtained by welding metal members made of different materials has an excellent balance between rigidity and light weight, and therefore is applied to vehicle components.

Japanese Unexamined Patent Application (Translation of PCT Application), Publication No. 2015-501877 discloses welding an aluminum alloy component and a zinc-coated steel component.

Patent Document 1: Japanese Unexamined Patent Application (Translation of PCT Application), Publication No.2015-501877

### SUMMARY OF THE INVENTION

However, since an intermetallic compound is formed at the root, the joining strength of the joined member may be reduced. Furthermore, since blowholes are generated at the root, there is a concern that the strength of the joined member is reduced.

An object of the present disclosure is to provide a joined member capable of suppressing formation of an intermetallic compound and generation of blowholes at the root, and a method of manufacturing the joined member.

According to an aspect of the present disclosure, a joined member includes: a first metal member, a second metal member opposed to the first metal member, and a joining portion through which the first metal member and the second metal member are joined together, in which an end face in a width direction of the first metal member is in contact with the joining portion, a material of the second metal member is different from a material of the first metal member, a portion of a surface of the second metal member on a side opposed to the first metal member is in contact with the joining portion, and a region of the surface of the second metal member on a side opposed to the first metal member which is not in contact with the joining portion is covered with zinc, and in the joining portion, zinc concentration in at least one end portion in the width direction is higher than zinc concentration in the center portion in the width direction.

In the joining member, zinc concentration in the end portion adjacent to the first metal member in the width direction may be higher than zinc concentration in the center portion in the width direction.

In the joining portion, zinc concentration in an end portion on a side opposite to the first metal member in the width direction may be higher than zinc concentration in the center portion in the width direction.

According to another aspect of the present disclosure, a method of manufacturing a joined member by joining a second metal member covered with zinc and a first metal member opposed to the second metal member, includes: applying a heat source to a filler material to melt the filler material, thereby forming a raised portion on a surface of the second metal member covered with the zinc; and applying a heat source to the first metal member to melt the first metal member, thereby causing the first metal member to join to the raised portion formed on the second metal member, in which a material of the second metal member is different from a material of the first metal member.

According to an embodiment of the present disclosure, it is possible to provide a joined member capable of suppressing the formation of an intermetallic compound and the generation of blowholes at a root, and a method of manufacturing the joined member.

### BRIEF DESCRIPTION OF THE DRAWINGS

FIG. 1 is a cross-sectional view showing an example of a joined member of an embodiment of the present disclosure.

FIGS. 2A to 2D are schematic views each showing an example of a method of manufacturing the joined member of the present embodiment.

FIG. 3 is a view showing an example of a laser welding machine used in the method of manufacturing the joined members of FIGS. 2A to 2D.

FIG. 4 is a cross-sectional SEM image of a raised portion in Example 1.

FIG. 5 is a cross-sectional SEM image of a joined member of Comparative Example 1.

### DETAILED DESCRIPTION OF THE INVENTION

Hereinafter, embodiments of the present disclosure will be described with reference to the accompanying drawings.

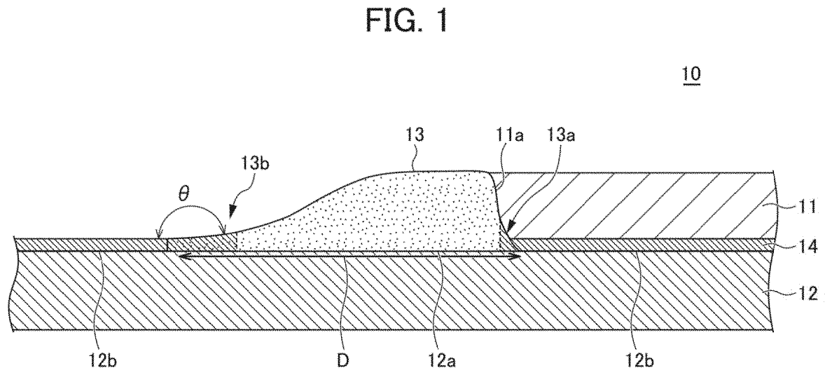

FIG. 1 shows an example of a joined member of an embodiment of the present disclosure.

In a joined member 10, a first metal plate 11 serving as a first metal member and a second metal plate 12 serving as a second metal member opposed to the first metal plate 11 are joined via a joining portion 13. At this time, one end face 11a in the width direction D of the first metal plate 11 is in contact with the joining portion 13. Furthermore, a portion 12a of the surface of the second metal plate 12 opposed to the first metal plate 11 is in contact with the joining portion 13. Furthermore, a zinc-plated layer 14 is provided in a region of the second metal plate 12 which is not in contact with the joining portion 13 on the surface on a side of the second metal plate 12 opposed to the first metal plate 11, that is, in a remaining portion 12b of the surface of the second metal plate 12 on a side opposed to the first metal plate 11. Furthermore, the material of the second metal plate 12 is different from that of the first metal plate 11.

Here, in the joining portion 13, the zinc concentration in at least one end portion in the width direction D is higher than the zinc concentration in the center portion in the width direction D. Therefore, in at least one end portion in the width direction D in the joining portion 13, formation of an intermetallic compound between the metal of the first metal plate 11 and the metal of the second metal plate is suppressed. As a result, a fracture starting at the intermetallic compound will hardly occur, so that the joining strength of the joined member 10 is improved. Specifically, when the zinc concentration in the end portion of the joining portion 13 adjacent to the first metal plate 11 in the width direction D, that is, the zinc concentration of the root 13a, is higher than the zinc concentration in the central portion of the joining portion 13 in the width direction D, the peel stress of the joined member 10 increases. Furthermore, when the zinc concentration in the end portion of the joining portion 13 on the side opposite to the first metal plate 11 in the width direction D, i.e., the zinc concentration at a stop end portion or a toe of weld 13b, is higher than the zinc concentration in the central portion of the joining portion 13 in the width direction D, the flank angle θ becomes large, so that stress concentration of the shear stress, the tensile stress, and the peeling stress at the stop end portion 13b is suppressed.

In the joined member 10, the first metal plate 11 and the second metal plate 12 are used as the first metal member and the second metal member, respectively. However, the shapes of the first metal member and the second metal member are not particularly limited.

The application of the joined member of the present embodiment is not particularly limited, but examples thereof include vehicle components. Specific examples of the vehicle component include a side panel outer made of aluminum in a multi-material body made using iron and aluminum.

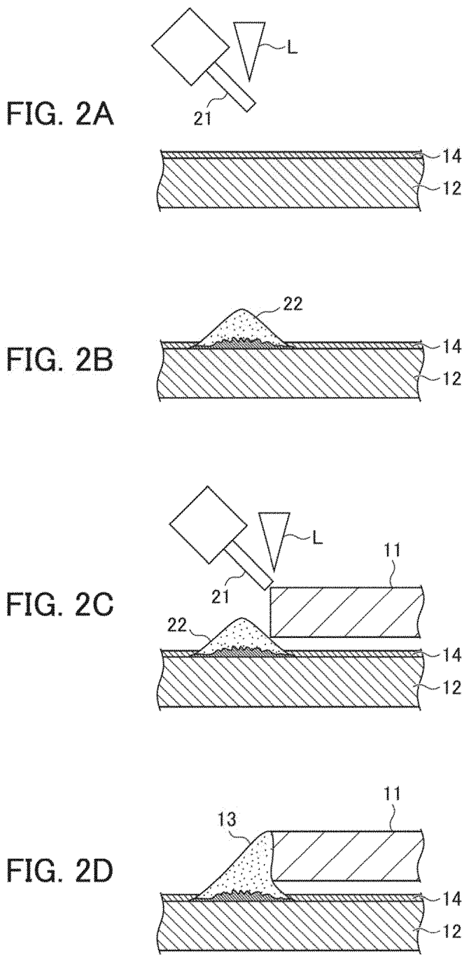

FIGS. 2A to 2D each show an example of a method of manufacturing the joined member of the present embodiment.

The method of manufacturing the joined member herein refers to a method of manufacturing a joined member by joining the second metal plate 12 on which the zinc-plated layer 14 is formed, serving as the second metal member coated with zinc, and the first metal plate 11 serving as the first metal member opposed to the second metal plate 12.

More specifically, first, while scanning in the depth direction of the first metal plate 11, a laser beam L is irradiated to a wire-shaped filler material 21 and the wire-shaped filler material 21 is melted (refer to FIG. 2A), whereby a raised (padding) portion 22 is formed on the surface of the second metal plate 12 on the side where the zinc-plated layer 14 is formed (refer to FIG. 2B). Since the heights at both end portions in the width direction D of the raised portion 22 are lower than the height at the center portion in the width direction D, the zinc concentrations in both end portions in the width direction D are higher than the zinc concentration in the center portion in the width direction D. Furthermore, the flank angles at both ends of the raised portion 22 in the width direction D increase. At this time, it is preferable that, for example, the zinc-plated layer 14 is heated and melted in advance by irradiating a laser beam to a region of the second metal plate 12 where the raised portion 22 is to be formed. With such a configuration, the molten filler material 21 is likely to spread on the molten zinc-plated layer 14. Here, the width direction D of the raised portion 22 is the same as the width direction D of the joining portion 13, and is a direction perpendicular or substantially perpendicular to the scanning direction of the laser beam L (the depth direction of the first metal plate 11) and the thickness direction of the second metal plate 12.

Next, the first metal plate 11 is disposed in the vicinity of the center portion of the raised portion 22, and the laser beam L is irradiated to the filler material 21 and the end portion adjacent to the raised portion 22 in the width direction D of the first metal plate 11, while scanning in the depth direction of the first metal plate 11 so that they are melted (see FIG. 2C), whereby the first metal plate 11 is joined to the raised portion 22, i.e., the first metal plate 11 and the second metal plate 12 are joined together via the joining portion 13 (see FIG. 2D). As described above, by making the method of manufacturing the joined member as two steps, it is possible to reduce the heat input to the zinc-plated layer 14 in the region corresponding to the root of the joined member, and it is also possible to control the temperature of the zinc-plated layer 14 to fall within a range in which the boiling of the zinc is suppressed, whereby the generation of blow holes is suppressed. As a result, the zinc concentration in the end portion of the joining portion 13 adjacent to the first metal plate 11 in the width direction D increases.

The second metal plate 12 on which the zinc-plated layer 14 is formed is not particularly limited, and examples thereof include an alloyed zinc-plated steel sheet and a molten zinc-plated steel sheet. Among them, the molten zinc-plated steel sheet is preferable.

The melting point of the second metal plate 12 is not particularly limited and is, for example, 1496° C. or higher and 1536° C. or lower.

The thickness of the second metal plate 12 is not particularly limited and is, for example, 0.5 mm or more and 3.0 mm or less.

The zinc-plated layer 14 has a melting point of 419.5° C. and a boiling point of 907° C.

The thickness of the zinc-plated layer 14 is not particularly limited and is, for example, 0.0028 mm or more and 0.014 mm or less.

The metal of the filler material 21 is not particularly limited, and examples thereof include aluminum and an aluminum alloy. Examples of the aluminum alloy include an Al—Mn alloy, an Al—Mg alloy, an Al—Mg—Si alloy, an Al—Cu alloy, an Al—Zn—Mg alloy, and an Al—Si alloy. Among them, an Al—Si alloy is preferable.

The melting point of the filler material 21 is not particularly limited and is, for example, 577° C. or higher and 660° C. or lower.

The diameter of the wire-shaped filler material 21 is not particularly limited and is, for example, 1.0 mm or more and 2.0 mm or less.

Although the wire-shaped filler material 21 is used in FIGS. 2A and 2C, the shape of the filler material is not limited to the wire shape and may be, for example, powder form, granular, plate-like, or the like.

Furthermore, in FIG. 2C, the filler material 21 is melted together with the end portion of the first metal plate 11 adjacent to the raised portion 22 in the width direction D. However, the filler material 21 may not be used, and only the end portion of the first metal plate 11 adjacent to the raised portion 22 in the width direction D may be melted.

Furthermore, the filler material 21 used in FIG. 2A may be the same as or different from the filler material 21 used in FIG. 2C.

The first metal plate 11 is not particularly limited, and examples thereof include an aluminum plate and an aluminum alloy plate. The aluminum alloy of the aluminum alloy plate is the same as the aluminum alloy of the filler material 21. Among them, an Al—Mg—Si aluminum alloy is preferable.

The melting point of the first metal plate 11 is not particularly limited and is, for example, 577° C. or higher and 660° C. or lower.

The metal of the first metal plate 11 may be the same as or different from the metal of the filler material 21.

The thickness of the first metal plate 11 is not particularly limited and is, for example, 0.5 mm or more and 5.0 mm or less.

The method of manufacturing the joined member of the present embodiment is not particularly limited as long as the temperature of the zinc-plated layer 14 in the region corresponding to the root of the joined member can be controlled within a range in which the boiling of zinc is suppressed, and may not be established in two steps.

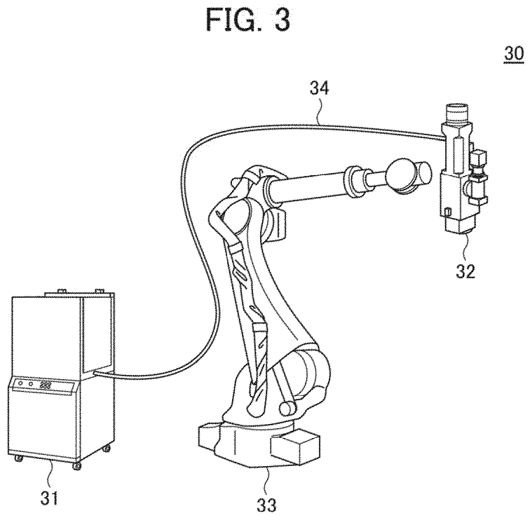

FIG. 3 shows an example of a laser welding machine used in the method of manufacturing the joined member of FIGS. 2A to 2D.

The laser welding machine 30 includes an oscillator 31 that generates a laser beam L, a laser head 32 that irradiates the laser beam L generated by the oscillator 31, and a robot 33 that operates the laser head 32. Here, the oscillator 31 and the laser head 32 are connected via an optical fiber 34.

The oscillator 31 is not particularly limited as long as the generated laser beam L can be transmitted by an optical fiber, and examples thereof include a fiber laser, a diode laser, and a disc laser.

The center wavelength, output, etc. of the laser beam L can be appropriately set according to the manufacturing conditions (e.g., material, thickness, etc.) of the joined member.

The laser head 32 is not particularly limited, and examples thereof include a fixed optical head, a variable optical head, beam shaping (single beam, twin beam, or the like) by a diffractive optical element (DOE), and a galvano head.

The robot 33 is not particularly limited, and examples thereof include industrial general-purpose robots.

The portable weight, movable range, accuracy, and the like of the robot 33 are not particularly limited.

In the manufacturing method of the joined member of the present embodiment, a heat source other than the laser beam L, that is, a welding machine other than the laser welding machine, may be used.

Examples of welding machines other than the laser welding machine include well-known MIG welding machines, CMT welding machines, arc welding machines, and the like.

The welding machine is preferably of temperature control type combining with a non-contact thermometer.

Although the embodiments of the present disclosure have been described above, the present disclosure is not limited to the above-described embodiments, and the above-described embodiments may be appropriately modified within the scope of the present disclosure.

### EXAMPLES

Hereinafter, although Examples of the present disclosure will be described, the present disclosure is not limited to these Examples.

### Example 1

The joined member was manufactured under the following conditions by the method of manufacturing the joined member shown in FIGS. 2A to 2D.

The first metal plate 11: Al—Mg—Si aluminum alloy plate; 1.0 mm thick

The second metal plate 12 on which the zinc-plated layer 14 is formed: molten zinc-plated steel sheets; 1.4 mm thick second metal plate 12; 0.007 mm thick zinc-plated layer 14 The filler material 21: Al—Si alloy wire, 1.2 mm diameter

In FIG. 2A, only the filler material 21 was irradiated with the laser beam L, and the moving speed of the laser head 32 in the scanning direction of the laser beam L, i.e., the scanning speed of the laser head 32, was set to 1 m/min. At this time, the zinc-plated layer 14 was heated and melted in advance by applying a laser beam to a region of the second metal plate 12 where the raised portion 22 was formed. Furthermore, in FIG. 2B, the temperatures at both end portions and the center portion in the width direction D of the molten raised portion 22 were 660° C. and 1100° C., respectively. Furthermore, in FIG. 2C, the laser beam L was applied to the filler material 21 and the end portion of the first metal plate 11 adjacent to the raised portion 22 in the width direction D, and the scanning speed of the laser head 32 was set to 1 m/min. In FIG. 2D, the temperature of the molten joining portion 13 was 800° C.

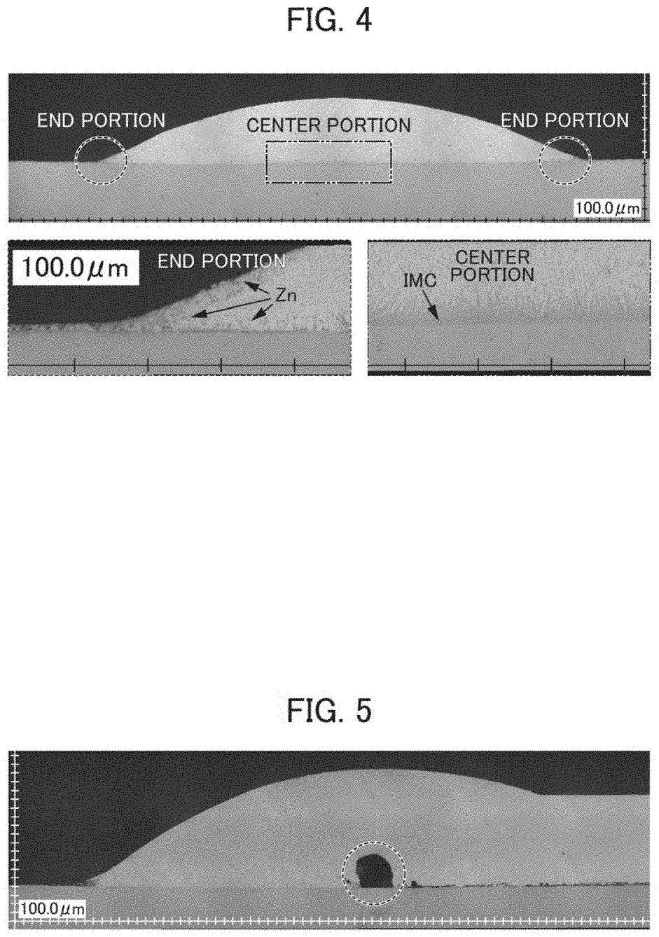

FIG. 4 shows a cross-sectional SEM image of the raised portion 22.

It is understood from FIG. 4 that no blowholes were generated in the raised portion 22. Since the Zn concentration was high at both end portions of the raised portion 22 in the width direction D, no intermetallic compound (IMC) was observed therein. On the other hand, an IMC having a thickness of about 30 μm was observed at the center portion of the raised portion 22 in the width direction D because the Zn concentration was low.

The same tendency as described above was observed in the joined member. It is assumed that this is because the temperature of the molten joining portion 13 was controlled so as to fall within a range in which the boiling of zinc was suppressed, similarly to the temperature of both end portions in the width direction D of the molten raised portion 22.

### Comparative Example 1

A joined member was produced in the same manner as in Example 1 except that the joining process of FIGS. 2A and 2B was omitted.

FIG. 5 shows a cross-sectional SEM image of the joined member.

It is understood from FIG. 5 that a blowhole was generated at the root of the joined member. IMC was observed at the root of the joined member. It is presumed that this due to the temperature of the molten root not being controlled so as to fall within a range in which the boiling of zinc was suppressed.

### EXPLANATION OF REFERENCE NUMERALS

10 joined member
11 first metal plate
11a end face
12 second metal plate
12a portion of surface
12b remaining portion of surface
13 joining portion
13a root
13b toe of weld (stop end portion)
14 zinc-plated layer
21 filler material
22 raised portion
30 laser welding machine
31 oscillator
32 laser head
33 robot
34 optical fiber
D width direction
L laser beam

What is claimed is:

1. A joined member comprising:
a first metal member, a second metal member opposed to the first metal member, and a joining portion through which the first metal member and the second metal member are joined together,
wherein an end face in a width direction of the first metal member is in contact with the joining portion,
a material of the second metal member is different from a material of the first metal member, a portion of a surface of the second metal member on a side opposed to the first metal member is in contact with the joining portion, and a region of the surface of the second metal member on a side opposed to the first metal member which is not in contact with the joining portion is covered with zinc, and
in the joining portion, zinc concentration in at least one end portion in the width direction is higher than zinc concentration in the center portion in the width direction.

2. The joined member according to claim 1, wherein, in the joining member, zinc concentration in the end portion adjacent to the first metal member in the width direction is higher than zinc concentration in the center portion in the width direction.

3. The joined member according to claim 1, wherein, in the joining portion, zinc concentration in an end portion on a side opposite to the first metal member in the width direction is higher than zinc concentration in the center portion in the width direction.

4. A method of manufacturing a joined member by joining a second metal member covered with zinc and a first metal member opposed to the second metal member, the method comprising:
applying a heat source to a filler material to melt the filler material, thereby forming a raised portion on a surface on a side of the second metal member covered with the zinc; and
applying a heat source to the first metal member to melt the first metal member, thereby causing the first metal member to join to the raised portion formed on the second metal member,
wherein a material of the second metal member is different from a material of the first metal member.
